(19) United States
(12) Patent Application Publication
(10) Pub. No.: US 2006/0211788 A1
(43) Pub. Date: Sep. 21, 2006

(54) UV curable compositions for ink or paint applications

(76) Inventor: Roy C. Krohn, Fort Gratiot, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/378,678

(22) Filed: Mar. 17, 2006

Related U.S. Application Data
(60) Provisional application No. 60/663,190, filed on Mar. 18, 2005.

(51) Int. Cl. B29D 11/00

(52) U.S. Cl. 522/178

(57) ABSTRACT

A curable ink composition comprises at least one acrylated oligomer, a pigment, and two or more monomers. The two or more monomers include an ethylenically unsubstituted monomer and an acrylated polyol. The curable ink composition further includes one or more optional components which include UV inhibitors, adhesion promoters, flow modifying agents, and pigments. When the curable ink composition is to be cured by an e-beam, the composition is further characterized in being substantially free of any photoinitiators. When the curable ink composition is to be cured by light, a photoinitiator is included.

### CROSS-REFERENCE TO RELATED APPLICATIONS

This application claims the benefit of U.S. Provisional Application Ser. No. 60/663,190 filed Mar. 18, 2005.

### BACKGROUND OF THE INVENTION

1. Field of the Invention

The present invention relates to UV curable ink and paint compositions and to methods of applying such compositions to a substrate.

2. Background Art

Many printing applications utilize heat curable compositions or slowly curing room temperature paint compositions. In these applications, the desired text or logo is applied to a substrate and then thermally cured. Typically, such heat curable compositions require the use of organic solvents that contain a significant amount of volatile organic compounds (“VOCs”). These VOCs escape into the atmosphere while the heat curable coating dries. Such solvent-based systems are undesirable because of the hazards and expenses associated with VOCs. The hazards include water and air pollution, and the expenses include the cost of complying with strict government regulation on solvent emission levels. In contrast, electron beam and UV curable compositions contain reactive monomers instead of solvents, thus eliminating the detrimental effects of the VOCs.

UV curable coatings are cured through rapid photo-induced polymerizations instead of thermal energy which releases VOCs into the atmosphere. Since the UV curing process can be essentially solvent free, the necessity for time consuming and expensive pollution abatement procedures is greatly reduced. Similarly, electron beam curable coatings are also known in which curable compositions are cured by a directed electron beam instead of by thermal energy.

Both electron beam and UV curable coatings offer several other benefits not associated with thermally cured coatings. First, faster cure times offer substantial economic benefits. Furthermore, heat sensitive materials can be safely coated and cured with electron beams and UV light without thermal degradation of heat sensitive substrates. Additionally, UV light is a relatively low cost of energy due to its widespread availability.

Accordingly, there exists a need to provide environmentally safe curable ink compositions which exhibit improved performance.

### SUMMARY OF THE INVENTION

The present invention overcomes the problems encountered in the prior art by providing a curable ink composition that contains less than about 10% volatile organic compounds. The curable ink composition is curable by exposure to an electron beam (“e-beam”). The curable ink composition of the present invention comprises at least one acrylated oligomer, an optional pigment, and two or more monomers. The two or more monomers include an ethylenically unsubstituted monomer and an acrylated polyol. The curable ink composition of the present invention further includes one or more optional components which include UV inhibitors, adhesion promoters, flow modifying agents, and pigments. When the curable ink composition is to be cured by an e-beam, the composition is further characterized in being substantially free of any photoinitiators.

In another embodiment of the invention, a photocurable composition useful for paint and ink applications is provided. The photocurable composition is the same as the curable compositions set forth above in the first embodiment but further comprising a photoinitiator. Accordingly, the photocurable composition of this embodiment also has less than about 10% volatile organic compounds or solvents.

In yet another embodiment of the invention, a method of applying the e-beam curable and photocurable compositions of the invention are provided. In one variation, the e-beam composition is applied to a substrate to form a coated substrate that is subsequently cured by exposing the coated substrate to an electron beam. In a second variation, the photocurable composition is applied to a substrate to form a coated substrate. The coated substrate is then cured by exposing the coated substrate with light of sufficient intensity, wavelength (typically ultraviolet (“UV”)), and duration to cure the photocurable composition.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventor.

The term “polymer” as used herein refers to a molecule of relatively high molecular mass made up by the repetition of a simpler molecule of low relative molecular mass.

The term “degree of polymerization” as used herein refers to the number of repeating simpler molecules.

The term “oligomer” as used herein refers to a molecule of intermediate molecular mass. Oligomers often comprise a small plurality of lower molecular mass molecule. Moreover, oligomers will typically have a degree of polymerization from 2 to 20.

The term “polyurethane” as used herein refers to polymers containing urethane groups (—NH—CO—O—) typically created by reacting isocyanates with polyols and chain extenders.

The term “aliphatic” as used herein refers to non-aromatic saturated or unsaturated linear or branched hydrocarbon groups which include for example alkyl, alkenyl, and alkynyl groups.

The term “acrylated” as used herein refers to monoacrylated, monomethacrylated, multi-acrylated, and multi-methacrylated monomers, oligomers or polymers.

The term “polyol” as used herein refers to a molecule that has several hydroxyl groups per molecule.

The term “an isobornyl acrylate” as used herein refers to a monomer having an isoborynyl group and at least one acrylate group.

In an embodiment of the present invention, a curable ink composition that contains less than about 10 wt % volatile organic compounds is provided. The curable ink composition of the invention is advantageously curable by electron beams (“e-beams”) and when a photoinitiator is present, the composition is curable by light and in particular UV light. The curable composition of the present invention comprises at least one acrylated oligomer, a pigment, and two or more monomers. The two or more monomers include an ethylenically unsubstituted monomer and an acrylated polyol. The curable ink composition of the present invention further includes one or more optional components which include UV inhibitors, adhesion promoters, flow modifying agents, and pigments. When the curable ink composition is to be cured by an e-beam, the composition is further characterized in being substantially free of any photoinitiators.

The curable ink composition includes at least one acrylated oligomer selected from the group consisting of an acrylated epoxy oligomer, an acrylated polyester oligomer, acrylated silicone oligomer, acrylated acrylic oligomer, acrylated urethane oligomer, an acrylated melamine oligomer, and mixtures thereof. More preferably, the curable ink composition includes an acylated urethane oligomer. Most preferably, the curable ink composition includes an acrylated aliphatic urethane oligomer. In some variations of the invention, the at least one acrylated oligomer is present in an amount from about 1% to 50% of the total weight of the curable ink composition.

Particularly useful acrylated oligomers are aliphatic acrylated oligomers. In a variation of this first embodiment, one or more aliphatic acrylated oligomers are present in an amount from about 1% to 50% of the total weight of the curable ink composition. All percentages are weight percentages of the total weight of the curable ink composition (whether e-beam or photocurable) unless stated otherwise. In another variation of this first embodiment, the one or more aliphatic acrylated oligomers are present in an amount of about 10% to 30% of the total weight of the curable ink composition. In yet another variation of this first embodiment, the one or more aliphatic acrylated oligomers are present in an amount of about 20% of the total weight of the curable ink composition. The aliphatic acrylated oligomer preferably comprises one or more urethane oligomers. Suitable aliphatic acrylated oligomers include Radcure Ebecryl 244 (aliphatic urethane diacrylate diluted 10% by weight with 1,6-hexanediol diacrylate), Ebecryl 264 (aliphatic urethane triacrylate diluted 15% by weight with 1,6-hexanediol diacrylate), Ebecryl 284 (aliphatic urethane diacrylate diluted 12% by weight with 1,6-hexanediol diacrylate) urethanes, commercially available from Radcure UCB Corp. of Smyrna, Ga.; Sartomer CN-961E75 (aliphatic urethane diacrylate blended with 25% by weight ethoxylated trimethylol propane triacylate), CN-961H81 (aliphatic urethane diacrylate blended with 19% by weight 2(2-ethoxyethoxy)ethyl acrylate), CN-963A80 (aliphatic urethane diacrylate blended with 20% by weight tripropylene glycol diacrylate), CN-964 (aliphatic urethane diacrylate), CN-966A80 (aliphatic urethane diacrylate blended with 20% by weight tripropylene glycol diacrylate), CN-982A75 (aliphatic urethane diacrylate blended with 25% by weight tripropylene glycol diacrylate) and CN-983 (aliphatic urethane diacrylate), commercially available from Sartomer Corp. of Exton, Pa.; TAB FAIRAD 8010, 8179, 8205, 8210, 8216, 8264, M-E-15, UVU-316, commercially available from TAB Chemicals of Chicago, Ill.; and Echo Resin ALU-303, commercially available from Echo Resins of Versaille, Mo.; and Genomer 4652, commercially available from Rahn Radiation Curing of Aurora, Ill. Ebecryl 264 is an aliphatic urethane triacrylate of 1200 molecular weight supplied as an 85% solution in hexanediol diacrylate. Ebecryl 284 is an aliphatic urethane diacrylate of 1200 molecular weight diluted 10% with 1,6-hexanediol diacrylate. Combinations of these materials may also be employed herein. The preferred aliphatic urethanes is a combination of Ebecryl 8807 and Ebecryl 1136.

In a particularly useful variation of the first embodiment, the curable ink composition includes in addition to the one or more aliphatic acrylated oligomers, a second acrylated oligomer which is an acrylic oligomer. Typically, the acrylic acrylate is present in an amount from about 1% to 50% of the total weight of the curable ink composition. In another variation of this first embodiment, the acrylic acrylate is present in an amount from about 8% to 25% of the total weight of the curable ink composition. In yet another variation of this first embodiment, the acrylic acrylate is present in an amount of about 15% of the total weight of the curable ink composition. A particularly useful acrylic oligomer is CN 132 commercially available from Sartomer Company, Inc. CN 132 is an aliphatic diacrylate oligomer.

The curable ink composition of the present embodiment also includes two or more monomers. In one variation, the two or more monomers include a first monomer and a second monomer. The two or more monomers are present in a sufficient amount that the viscosity of the curable ink composition is from about 50 to about 400,000 centripoise at 25° C. In another variation, the two or more monomers are present in an amount from about 0.2% to about 76% of the total weight of the curable ink composition. The first monomer of this embodiment is an ethylenically unsaturated monomer having Formula I: 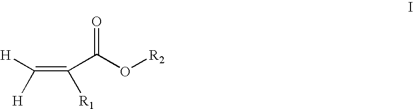
wherein R₁ is hydrogen or substituted or unsubstituted alkyl; and R₂ is substituted or unsubstituted alkyl having more than 4 carbon atoms, cycloalkyl, cycloalkenyl, or substituted or unsubstituted aryl. Preferably R₁ is hydrogen or methyl; and R₂ is isoborynl, phenyl, benzyl, dicylcopentenyl, dicyclopentenyl oxyethyl, ethylene glycol dicyclopentyl ether, cyclohexyl, and naphthyl. The most preferred ethyleneically unsaturated monomers are isobornyl acrylate monomers. In a variation of this embodiment, ethylenically substituted monomer is present in an amount from about 0.1% to 66% of the total weight of the curable ink composition. In another variation of this embodiment, ethylenically substituted monomer is present in an amount from about 10% to 30% of the total weight of the curable ink composition. In yet another variation of this embodiment, the ethylenically substituted monomer is present in an amount of about 18% of the total weight of the curable ink composition. Suitable isobornyl acrylate monomers include Sartomer SR-423 (isobornyl methacrylate): 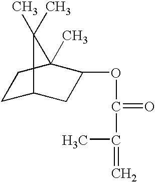
and SR-506 (isobornyl acrylate):

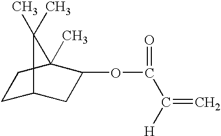

The second monomer includes an acrylated polyol momomer in which the hydroxyl groups of a polyol are acrylated. In one variation, the acrylated polyol momomer is present in an amount from about 0.1% to about 10% of the total weight of the photocurable composition. In another variation, the acrylated polyol momomer is present in an amount of about 0.5% to about 5% of the total weight of the curable ink composition. In still another embodiment of the invention, the acrylated polyol momomer is present in an amount of about 2% of the total weight of the curable ink photocurable composition. Suitable acrylated polyols include tripropylene glycol diacrylate (“TRPGDA”), dipropylene glycol diacrylate (“DPGDA”), 1,6-Hexanediol diacrylate (“HDODA”), trimethylolpropane ethoxy triacrylate (“TMPEOTA”) dipropylene glycol diacrylate (“DPGDA”), trimethylolpropane triacrylate (“TMPTA-N”), tripropylene glycol diacrylate (“TRPGDA”), and combinations thereof.

The curable ink composition of this embodiment optionally includes one or more pigments. In one variation of this embodiment, the pigments are present in an amount from about 0.1% to 40% of the total weight of the curable ink composition. In another variation of this embodiment, the pigments are present in an amount from about 10% to 25% of the total weight of the curable ink composition. In yet another variation of this embodiment, the pigments are present in an amount from about 15% to 25% of the total weight of the curable ink composition. Virtually any pigment material may be used as the one or more pigments. Suitable pigments include Tintyl-ayd PC 9003 titanium oxide available from Danial Products, Venus #91 pigment and Palegold #400 available from NazDar; and Al #200 pigment available from Silberlne. Suitable pigments include metallic and flatbase pigments commercially available from EM Industries. The preferred pigment used will depend on the desired color of the paint. Combinations of these materials may also be employed herein.

The curable ink composition of the invention optionally includes one or more UV absorbers (i.e., a UV stabilizer). In a variation of this embodiment, the UV absorbers are present in an amount from about 0.1 to about 10% of the total weight of the curable ink composition. In another variation of this embodiment, the UV absorbers are present in an amount from about 1% to about 5% of the total weight of the curable ink composition. In yet another variation of this embodiment, the UV absorbers are present in an amount of about 2.6% of the total weight of the curable ink composition. Suitable UV stabilizers include, but are not limited to hindered amine light stabilizers (“HALS”). Examples of HALS include: Chimassorb 944, Chimassorb 994, Chimassorb 905, Tinuvin 770, Tinuvin 992, Tinuvin 622, Tinuvin 144, Tinuvin 123, Tinuvin 400, and Spinuvex A36 available from Geigy; and Cyasorb UV 3346 and Cyasorb UV 944 commercially available American Cyanamide. A particularly useful UV absorber is obtained by a combination of Tinuvin 123 and Tinuvin 400.

The curable composition optionally comprises an adhesion promoter in an amount of 1% to 10% of the total weight of the curable ink composition. In another variation, the curable composition comprises an adhesion promoter in an amount of 2% to 7% of the total weight of the curable ink composition. In yet another variation of the invention, the curable composition comprises an adhesion promoter in an amount of about 4% of the total weight of the curable ink composition. Suitable adhesion promoters include Ebecryl 168 commercially available from Raducure.

In a second embodiment of the present invention, a photocurable composition suitable for ink and paint applications is provided. The photocurable composition of this embodiment comprises the curable composition set forth above in the first embodiment further comprising a photoinitiator. In one variation, the photoinitiator is present in an amount from between about 0.0% and about 10% of the total weight of the photocurable composition. In another variation, the photoinitiator is present in an amount of about 0.1% to about 8% of the total weight of the photocurable composition. In still another embodiment of the invention, the photoinitiator is present in an amount from about 1% to about 7% of the total weight of the photocurable composition. Suitable photoinitiators include Irgacure 184 (1-hydroxycyclohexyl phenyl ketone), Irgacure 907 (2-methyl-1-[4-(methylthio)phenyl]-2-morpholino propan-1-one), Irgacure 369 (2-benzyl-2-N,N-dimethylamino-1-(4-morpholinophenyl)-1-butanone), Irgacure 500 (the combination of 50% by weight 1-hydroxy cyclohexyl phenyl ketone and 50% by weight benzophenone),Irgacure 651 (2,2-dimethoxy-2-phenyl acetophenone), Irgacure 1700 (the combination of 25% by weight bis(2,6-dimethoxybenzoyl-2,4-,4-trimethyl pentyl) phosphine oxide, and 75% by weight 2-hydroxy-2-methyl-1-phenyl-propan-1-one), Darocur 1173 (2-hydroxy-2-methyl-1-phenyl-1-propanone) and Darocur 4265 (the combination of 50% by weight 2,4,6-trimethylbenzoyldiphenyl-phosphine oxide, and 50% by weight 2-hydroxy 2-methyl-1-phenyl-propan-1-one), available commercially from Ciba-Geigy Corp., Tarrytown, N.Y.; CYRACURE UVI-6974 (mixed triaryl sulfonium hexafluoroantimonate salts) and CYRACURE UVI-6990 (mixed triaryl sulfonium hexafluorophosphate salts) available commercially from Union Carbide Chemicals and Plastics Co. Inc., Danbury, Conn.; and Genocure CQ, Genocure BOK, and Genocure M.F., commercially available from Rahn Radiation Curing. Combinations of these materials may also be employed herein. The preferred photoinitiator is a mixture of Irgacure 1800 and Darocur 1173.

In another embodiment of the present invention, the pigment in the first or second embodiment may be eliminated to form a composition that provides a clear ink. In this embodiment the weight percentages and selection of ingredients is the same as for the first or second embodiment.

The following examples illustrate the various embodiments of the present invention. Those skilled in the art will recognize many variations that are within the spirit of the present invention and scope of the claims.

The curable ink composition of example 1 is made by loading the isobornyl acrylate and TMPEOTA into a vessel and stirring until the mixture is of uniform composition. The CN132 and CN996 are then added and the resulting mixture further stirred until uniform. The Tinuvin 123, Tinuvin 400, and Ebecryl 168 are added to the mixture and stirred until uniform. The white preblend (a pigment) is then added and subsequently stirred in.

### EXAMPLE 1

| | Approximate weight |
|---|---|
| Component | percent |
| Isobornyl Acrylate (monomer) | 18.2 |
| TMPEOTA (acrylated polyol monomer) | 2.1 |
| CN 132 (acrylic acrylate) | 14.6 |
| CN 996 (urethane oligomer) | 20.8 |
| Tinuvin 123 (UV absorber) | 1.6 |
| Tinuvin 400 (UV absorber) | 1.0 |
| Ebecryl 168 (adhesion promoter) | 4.2 |
| White preblend | 37.5 |
| Total | 100.0 |

White preblend

| | Approximate weight |
|---|---|
| Component | percent |
| Isobornyl Acrylate | 38.5 |
| PC 9003 (white TiO2 powder) | 61.5 |
| Total | 100.0 |

Method for Depositing a Curable Ink Composition

In accordance with still another aspect of the invention, a method is provided for depositing an ink or paint coating on a substrate. The method comprises a first step of applying the curable ink composition to the substrate. In one variation of this embodiment, the e-beam curable ink composition set forth above is applied to the substrate. In another variation of this embodiment, the photocurable composition set forth above is applied to the substrate.

The compositions of the invention are applied to the substrate using a number of different techniques. The compositions may be applied, for example, by direct brush application, or it may be sprayed onto the substrate surface. It also may be applied using a screen printing technique. In such screen printing techniques, a “screen” as the term is used in the screen printing industry is used to regulate the flow of liquid composition onto the substrate surface. The compositions typically would be applied to the screen as the latter contacts the substrate. The compositions flow through the silk screen to the substrate, whereupon it adheres to the substrate at the desired film thickness. Screen printing techniques suitable for this purpose include known techniques, but wherein the process is adjusted in ways known to persons of ordinary skill in the art to accommodate the viscosity, flowability, and other properties of the liquid-phase composition, the substrate and its surface properties, etc. Flexographic techniques, for example, using pinch rollers to contact the ink composition with a rolling substrate, also may be used.

The method includes a second step of curing the compositions that have been applied to the substrate. If the e-beam composition is applied to the substrate, curing is effected by an electron beam source. The photocurable composition is applied to the substrate, the coated substrate is illuminated with a light source and, in particular, ultraviolet light to cause the ink composition to cure. This illumination may be carried out in any number of ways, provided the ultraviolet light or radiation impinges upon the composition so that it is caused to polymerize to form the coating, layer, film, etc.

In either e-beam curing or photocuring, curing preferably takes place by free radical polymerization, which is initiated by an ultraviolet radiation source. The photoinitiator preferably comprises a photoinitiator, as described above.

When photocurable compositions are used, various ultraviolet light sources may be utilized, depending on the application. Preferred ultraviolet radiation sources for a number of applications include known ultraviolet lighting equipment with energy intensity settings of, for example, 125 watts, 200 watts, and 300 watts per square inch.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A curable ink composition comprising:
at least one acrylated oligomer;
an optional pigment,
two or more monomers comprising a first monomer and a second monomer, the first monomer being an ethylenically unsubstituted monomer and the second monomer being an acrylated polyol, wherein the ink composition contains less than about 10% volatile organic compounds.

2. The ink composition of claim 1 wherein the at least one acrylated oligomer is selected from the group consisting of an acrylated epoxy oligomer, an acrylated polyester oligomer, acrylated silicone oligomer, acrylated acrylic oligomer, acrylated urethane oligomer, an acrylated melamine oligomer, and mixtures thereof.

3. The ink composition of claim 1 wherein the at least one acrylated oligomer comprises an aliphatic acrylated oligomer.

4. The ink composition of claim 3, wherein the aliphatic acrylated oligomer is selected from the group consisting of:
a) aliphatic urethane diacrylate diluted 10% by weight with 1,6-hexanediol diacrylate;
b) aliphatic urethane triacrylate diluted 15% by weight with 1,6-hexanediol diacrylate);
c) aliphatic urethane diacrylate blended with 20% by weight tripropylene glycol diacrylate;
d) aliphatic urethane diacrylate blended with 25% by weight ethoxylated trimethylol propane triacrylate;
e) aliphatic urethane diacrylate blended with 19% by weight 2(2-ethoxyethoxy)ethyl acrylate;
f) aliphatic urethane diacrylate blended with 20% by weight tripropylene glycol diacrylate;
g) aliphatic urethane diacrylate blended with 20% by weight tripropylene glycol diacrylate;
h) aliphatic urethane diacrylate blended with 25% by weight tripropylene glycol diacrylate;
i) aliphatic urethane diacrylate; and
j) mixtures thereof.

5. The ultraviolet curable ink composition of claim 1 wherein the ethylenically unsaturated monomer is described by the formula:
CH₂═CR₁—COO—R₂
wherein R₁ is hydrogen or lower alkyl and R₂ is dicyclopentenyl oxyethyl, cyclohexyl, 3,3,5-trimethyl cyclohexyl, phenyl, benzyl, naphthyl, isobornyl, or mixtures thereof.

6. The ink composition of claim 5 wherein the ethylenically unsaturated monomer is selected from the group consisting of isobornyl acrylate, isobornyl methacrylate, and mixtures thereof.

7. The ink composition of claim 1 wherein:
the at least one acrylated oligomer is present in an amount from about 1% to 50% of the total weight of the curable ink composition; and
the monomer mixture is present in an amount from about 0.2% to about 76% of the total weight of the curable ink composition.

8. The ink composition of claim 1 wherein the pigment is present in an amount of about 0.1% to 40% of the total weight of the ink composition.

9. The ink composition of claim 1 further comprising a photoinitiator.

10. The ink composition of claim 9 wherein the photoinitiator is present in an amount from about 0.0% to about 10% of the total weight of the ink composition.

11. A method for coating a substrate with a curable ink composition, the method comprising:
applying the ink composition to the substrate to form a coated substrate, wherein the ink composition includes:
at least one acrylated oligomer;
an optional pigment,
two or more monomers comprising a first monomer and a second monomer, the first monomer being an ethylenically unsubstituted monomer and the second monomer being an acrylated polyol,
exposing the coated substrate to an electron beam source or a light source sufficient to cure the ink composition.

12. The method of claim 11, wherein the method of applying the ink composition is spraying.

13. The method of claim 11, wherein the method of applying the ink composition is screen printing.

14. The method of claim 11, wherein the method of applying the ink composition is dipping the substrate into the composition sufficiently to cause the composition to uniformly coat the substrate.

15. The method of claim 11, wherein the method of applying the ink composition is brushing.

16. The method of claim 11, wherein the method of applying the ink composition is selectively deposited to the substrate at predetermined locations.

17. The method of claim 11, wherein the acrylated oligomer is selected from the group consisting of acrylated epoxies, acrylated polyesters, acrylated silicones, acrylated acrylics, acrylated urethanes, acrylated melamines, and mixtures thereof.

18. The method of claim 11, wherein the at least one acrylated oligomer is an aliphatic acrylated urethane oligomer.

19. The method of claim 11, wherein the ethylenically unsaturated monomer is described by the formula:
CH₂═CR₁—COO—R₂
wherein R₁ is hydrogen or lower alkyl and R₂ is dicyclopentenyl oxyethyl, cyclohexyl, 3,3,5-trimethyl cyclohexyl, phenyl, benzyl, naphthyl, isobornyl, or mixtures thereof.

20. The method of claim 11, wherein the ethylenically unsaturated monomer is selected from the group consisting of isobornyl acrylate, isobornyl methacrylate, and mixtures thereof.
